(19) United States
(12) Patent Application Publication
(10) Pub. No.: US 2026/0333030 A1
(43) Pub. Date: Oct. 22, 2026

(54) OFFLINE EVENT PROCESSING USING PRE-AUTHORIZATION

(71) Applicant: Capital One Services, LLC, McLean, VA (US)

(72) Inventors: Gaurav VERMA, Princeton Junction, NJ (US); Creighton COOK, Richmond, VA (US); Alan CHEN, Arlington, VA (US)

(21) Appl. No.: 19/181,705

(22) Filed: Apr. 17, 2025

(51) Int. Cl. H04W 12/0431; H04W 12/08; H04L 9/40; H04W 12/06; H04W 12/062

(52) U.S. Cl. CPC H04W 12/0431; H04W 12/08; H04L 63/0823; H04L 63/083; H04W 12/06; H04W 12/062

(57) ABSTRACT

In some implementations, a user device may transmit, to a back-end server, a request for a key to confirm pre-authorization of the event, and may receive, from the back-end server, the key in response to the request for the key. The user device may transmit, to a client device, a request to process the event, and may receive, from the client device, a prompt for a message confirming pre-authorization of the event. The prompt may be received based on the client device lacking a connection with the back-end server, and the message may be associated with an account at the back-end server. The user device may transmit, to the client device, the message, generated using the key provided by the back-end server, in response to the prompt. The user device may receive, from the client device, a confirmation that the event was processed based on the message.

### BACKGROUND

In order to process an event, a client device generally communicates with a back-end server to verify an account being used for the event. However, the client device may lose a connection to the back-end server. For example, a local connection (e.g., a WiFi^{®} connection or a Bluetooth^{®} connection, among other examples) of the client device may fail, thus disconnecting the client device from the Internet. In another example, a cellular connection of the client device may fail, again disconnecting the client device from the Internet.

### SUMMARY

Some implementations described herein relate to a system for processing an event offline. The system may include one or more memories and one or more processors communicatively coupled to the one or more memories. The one or more processors may be configured to receive, from a user device, a request to process the event, wherein the event is associated with a back-end server, and the system lacks a connection with the back-end server. The one or more processors may be configured to transmit, to the user device, a prompt for a message confirming pre-authorization of the event, from the back-end server, wherein the message is associated with an account at the back-end server. The one or more processors may be configured to receive, from the user device, the message, generated using a key provided by the back-end server, in response to the prompt. The one or more processors may be configured to store the message from the user device. The one or more processors may be configured to process the event based on the message. The one or more processors may be configured to transmit, at a later time when the system has a connection with the back-end server, the message to the back-end server. The one or more processors may be configured to receive, from the back-end server, confirmation that the event has been verified.

Some implementations described herein relate to a method of processing an event offline. The method may include transmitting, from a user device and to a back-end server, a request for a key to confirm pre-authorization of the event. The method may include receiving, at the user device and from the back-end server, the key in response to the request for the key. The method may include transmitting, from the user device and to a client device, a request to process the event. The method may include receiving, at the user device and from the client device, a prompt for a message confirming pre-authorization of the event, wherein the prompt is received based on the client device lacking a connection with the back-end server, and wherein the message is associated with an account at the back-end server. The method may include transmitting, from the user device and to the client device, the message, generated using the key provided by the back-end server, in response to the prompt. The method may include receiving, at the user device and from the client device, a confirmation that the event was processed based on the message.

Some implementations described herein relate to a non-transitory computer-readable medium that stores a set of instructions for processing an event offline. The set of instructions, when executed by one or more processors of a device, may cause the device to receive, from a user device, a request for a key to confirm pre-authorization of the event. The set of instructions, when executed by one or more processors of the device, may cause the device to generate the key in response to the request for the key and store the key in association with an account at a back-end server. The set of instructions, when executed by one or more processors of the device, may cause the device to enforce a hold on the account based on pre-authorizing the event. The set of instructions, when executed by one or more processors of the device, may cause the device to transmit, to the user device, the key in response to the request for the key. The set of instructions, when executed by one or more processors of the device, may cause the device to receive, at a later time when a client device has a connection with the back-end server, a message from the user device that was generated using the key provided by the back-end server. The set of instructions, when executed by one or more processors of the device, may cause the device to verify the event and disable the hold on the account. The set of instructions, when executed by one or more processors of the device, may cause the device to transmit, to the client device, confirmation that the event has been verified.

### BRIEF DESCRIPTION OF THE DRAWINGS

FIGS. 1A-1B are diagrams of an example implementation relating to offline event processing using pre-authorization, in accordance with some embodiments of the present disclosure.

FIGS. 2A-2B are diagrams of example user interface flows associated with offline event processing using pre-authorization, in accordance with some embodiments of the present disclosure.

FIG. 3 is a diagram of an example environment in which systems and/or methods described herein may be implemented, in accordance with some embodiments of the present disclosure.

FIG. 4 is a diagram of example components of one or more devices of FIG. 3, in accordance with some embodiments of the present disclosure.

FIGS. 5-7 are flowcharts of example processes relating to offline event processing using pre-authorization, in accordance with some embodiments of the present disclosure.

### DETAILED DESCRIPTION

The following detailed description of example implementations refers to the accompanying drawings. The same reference numbers in different drawings may identify the same or similar elements.

A user may request that a client device process an event using an account of the user. For example, the user may use a user device, a physical card, or an input component of the client device to provide information associated with the account, and the client device may contact a back-end server to verify the information provided by the user and to authorize processing of the event.

However, the client device may lose a connection to the back-end server. For example, a network that the client device uses to connect to the back-end server (e.g., a local area network (LAN), a wide area network (WAN), a cellular network, an intranet, and/or the Internet, among other examples) may stop working (e.g., temporarily due to error). Therefore, the client device may be unable to use the back-end server to authorize processing of events.

The client device may instead process events in an offline mode. However, processing events offline increases a chance that the events will be rejected by the back-end server, which wastes power and processing resources in trying to rectify rejected events. Additionally, processing events offline usually involves a time requirement for providing the events to the back-end server after offline processing. For example, the client device may have 24 hours from processing an event offline to contact the back-end server, else the back-end server will reject the event. Therefore, the client device consumes memory and processing resources by managing a timer to ensure that events processed offline are sent to the back-end server before expiry of the timer.

Some implementations described herein enable a back-end server to pre-authorize an event in response to a request from a user device. Therefore, a client device may process the event by validating pre-authorization provided by the user device. As a result, the back-end server is unlikely to reject the event because the event was pre-authorized, which conserves power and processing resources that otherwise would have been spent in trying to rectify the event if rejected. Additionally, the back-end server may refrain from imposing a time requirement because the event was pre-authorized, and therefore the client device may conserve memory and processing resources that otherwise would have been spent on managing a timer associated with the event.

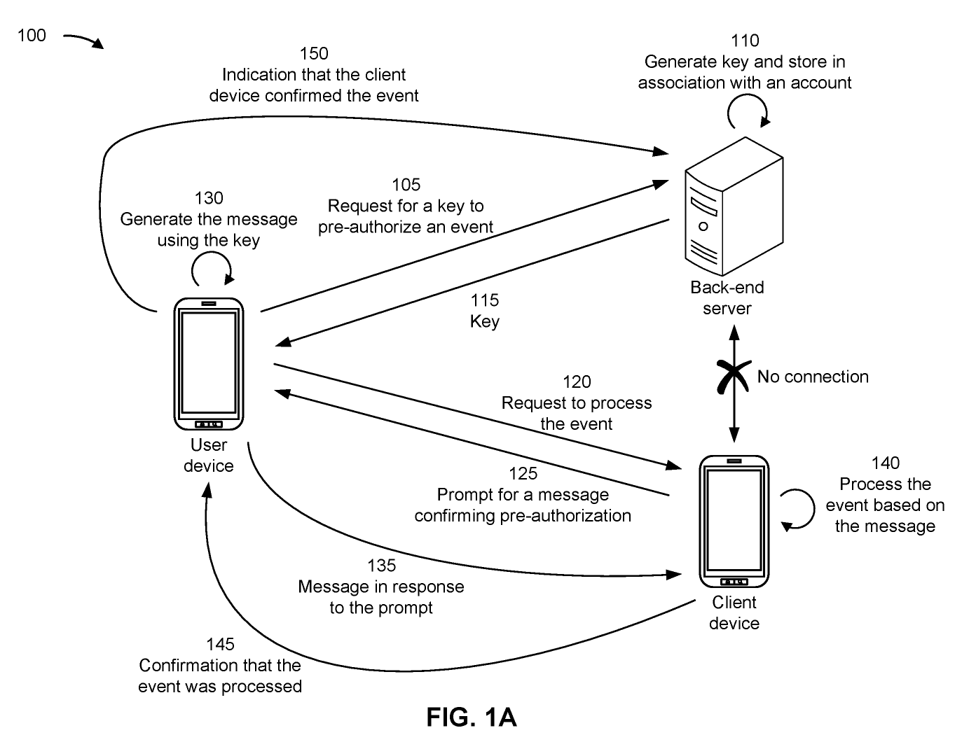

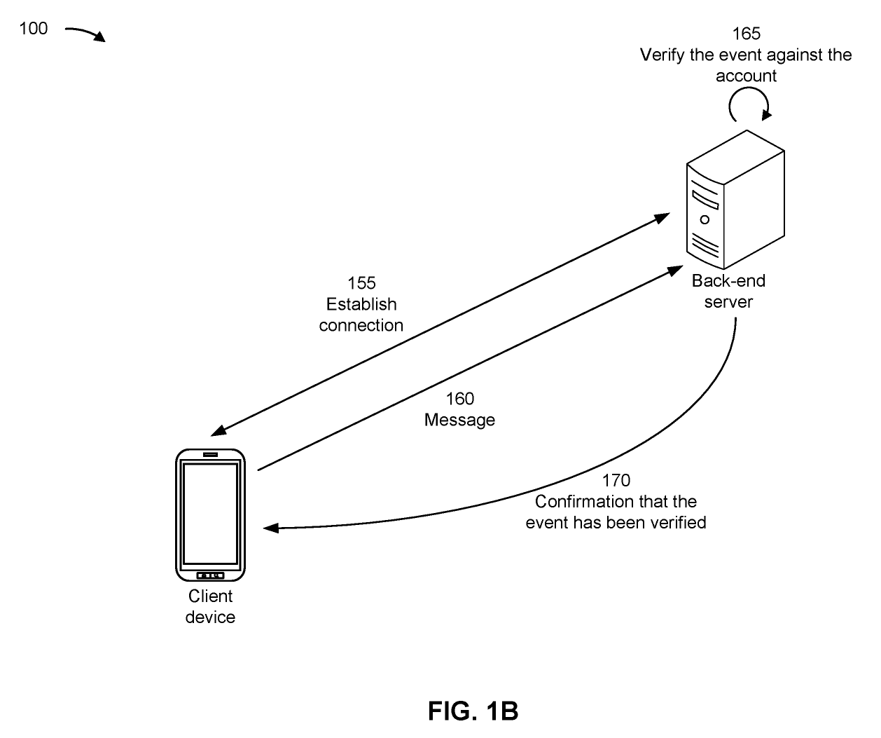

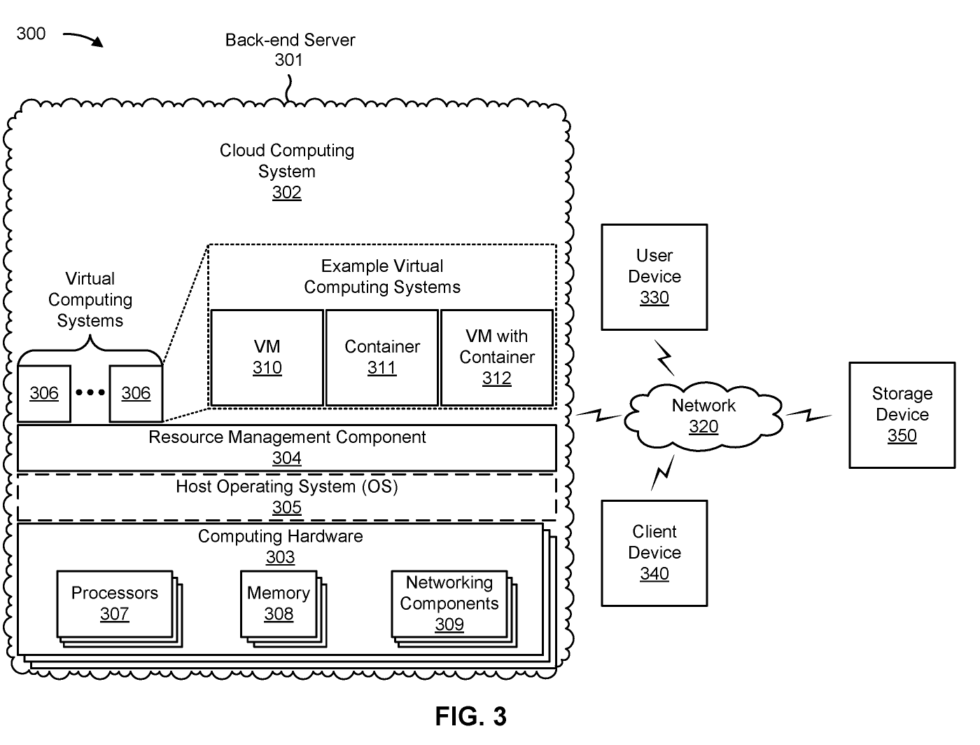

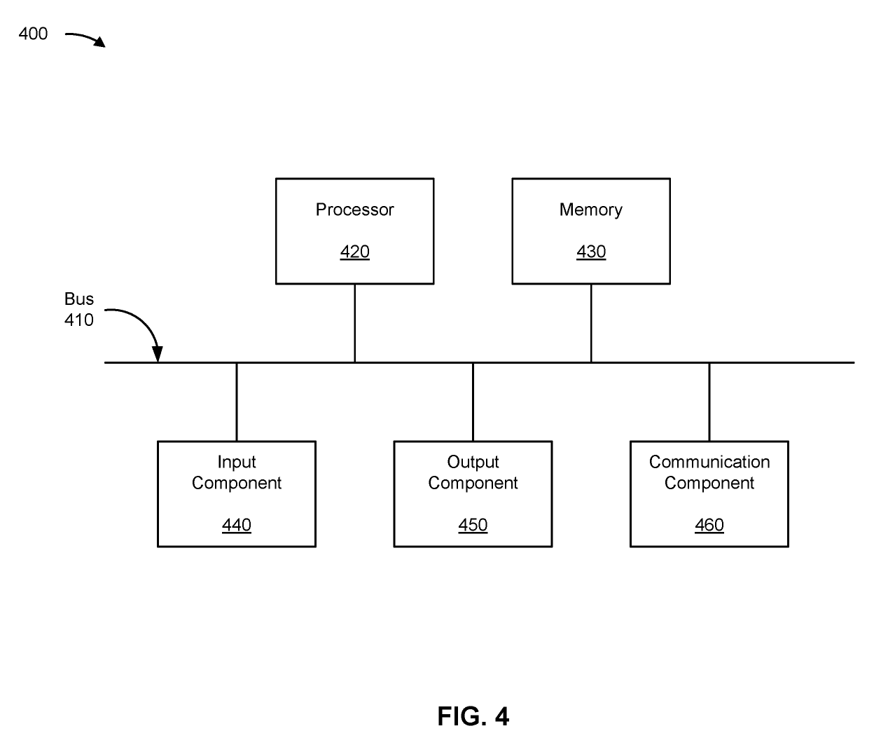

FIGS. 1A-1B are diagrams of an example 100 associated with offline event processing using pre-authorization. As shown in FIGS. 1A-1B, example 100 includes a user device, a back-end server, and a client device. These devices are described in more detail in connection with FIGS. 3 and 4.

As shown in FIG. 1A and by reference number 105, the user device may transmit, and the back-end server may receive, a request for a key to confirm pre-authorization of an event. The request may include a hypertext transfer protocol (HTTP) request, a file transfer protocol (FTP) request, and/or an application programming interface (API) call. The request may include (e.g., in a header and/or as an argument) an indication of the user device (e.g., a device name, an Internet protocol (IP) address, a medium access control (MAC) address, and/or another alphanumeric identifier associated with the user device) and/or an indication of the client device (e.g., a device name, an IP address, a MAC address, and/or another alphanumeric identifier associated with the client device) that will process the event. The request may additionally, or alternatively, include an indication of an account (associated with a user of the user device) to use to pre-authorize the event. For example, the indication of the account may include an account number, an account name, and/or an account type, among other examples.

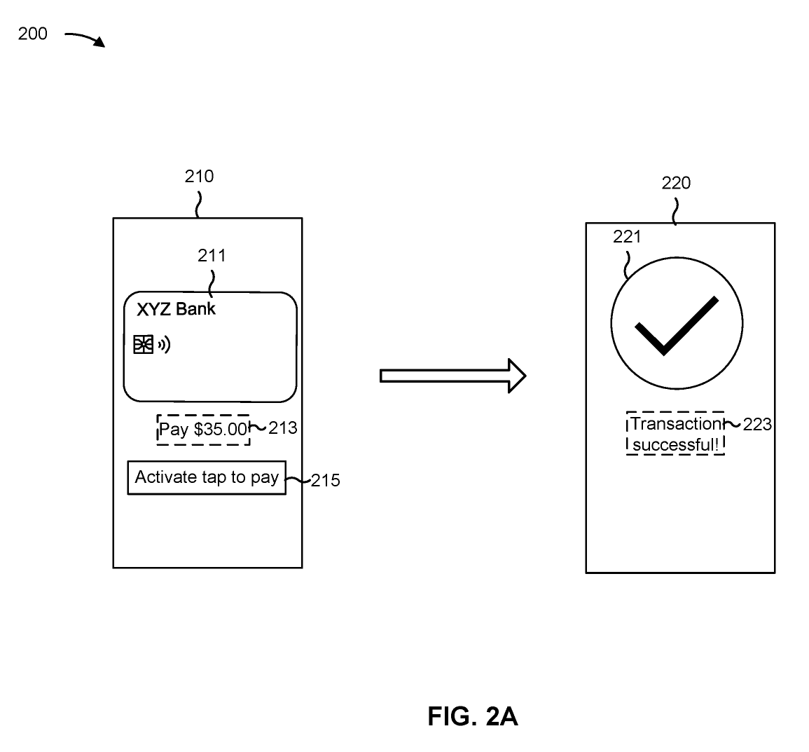

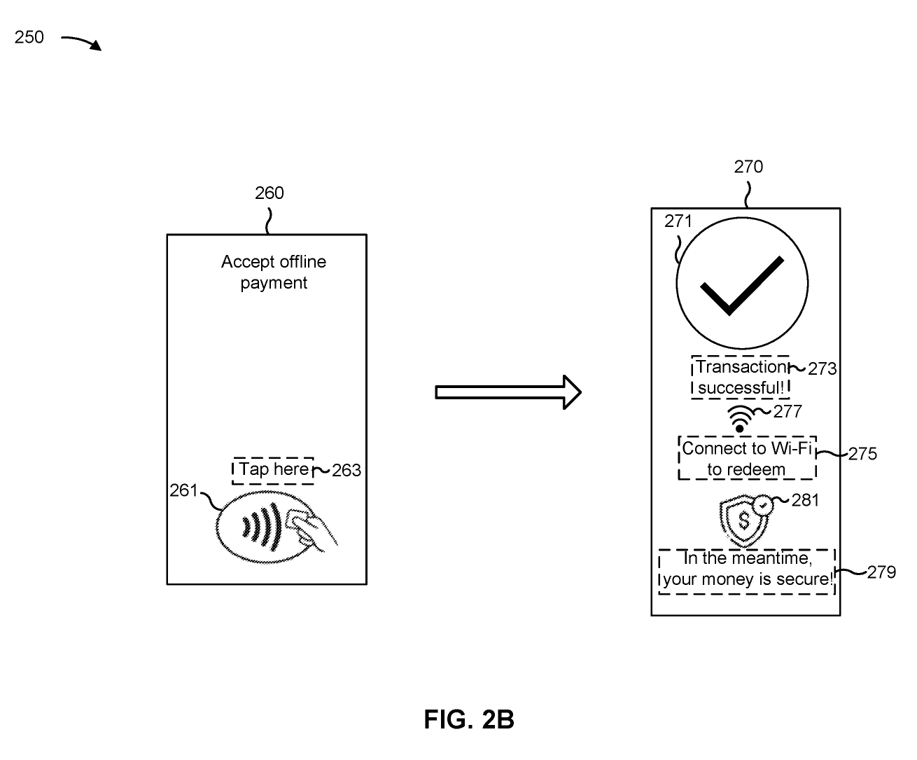

In some implementations, the user of the user device may provide input (e.g., via an input component of the user device) that triggers the user device to transmit the request. In one example, the user may interact with a user interface (UI) (e.g., output by an output component of the user device) to provide the input. The UI may be as described in connection with FIG. 2A. In another example, the user may provide text input (e.g., via a command prompt or a shell, among other examples) that triggers the user device to transmit the request. The input from the user may indicate an identifier of the client device, an identifier of the account, and/or another parameter to be included in the request.

In some implementations, the request may indicate an amount associated with the event. For example, the user may be at a point-of-sale (PoS) trying to complete a transaction, may discover that the client device lacks a connection with the back-end server, and may provide the back-end server with the amount that the user would like the back-end to pre-authorize so that the client device can process the transaction. Alternatively, the request may indicate a maximum amount. For example, the user may know that a physical location (e.g., a building or a neighborhood, among other examples) including the client device is associated with poor cellular service, and the user may trigger the user device to transmit the request in advance of traveling to the physical location so that the user may use the pre-authorization to avoid problems with event processing caused by the poor cellular service.

As shown by reference number 110, the back-end server may generate the key (in response to the request for the key) and may store the key in association with the account (at the back-end server). For example, the back-end server may derive a private key (e.g., using a master key from a key distribution center (KDC) or another key source) in response to the request. The private key may be unique to the back-end server and the user device and may be used to sign messages that confirm pre-authorization of the event.

To store the key in association with the account, the back-end server may enforce a hold on the account (based on pre-authorizing the event) and may store a flag in association with both the key and the account. The hold on the account may include a modification to a data structure (which represents the account) to prevent the amount (or the maximum amount) indicated in the request from being subtracted from the account. The flag may include a bit (or a plurality of bits) that are attached to the key and to (the data structure representing) the account so that the back-end server may later map the key to the account (and/or the account to the key).

Although the example 100 is described in connection with the back-end server storing the key and the data structure representing the account in a cache or another local memory, other examples may include the back-end server using a separate (e.g., physically, logically, and/or virtually) storage device (e.g., as described in connection with FIG. 3) to store the key and/or the data structure representing the account. Accordingly, the back-end server may use an API endpoint or another type of network-based communication to access the storage device.

In some implementations, the back-end server may validate a set of credentials from the user device before pre-authorizing the event (and generating the key). The set of credentials may include a username and password, a passcode, a personal identification number (PIN), a token, a (signed) certificate, and/or biometric information, among other examples. In one example, the user device may include the set of credentials in the request, such that the back-end server validates the set of credentials and processes the request in response to validating the set of credentials. In another example, the user device may transmit the set of credentials before the request, such that the back-end server validates the set of credentials and accepts the request from the user device in response to validating the set of credentials. In another example, the back-end server may prompt the user device in response to the request, and the user device may transmit the set of credentials in response to the prompt.

As shown by reference number 115, the back-end server may transmit, and the user device may receive, the key in response to the request for the key. The key may be included in an HTTP response, an FTP response, and/or a return from an API function. Accordingly, the user device may use a private key to confirm pre-authorization of the event (e.g., by signing a token, a certificate, or another type of message, using the key).

As shown by reference number 120, the user device may transmit, and the client device may receive, a request to process the event. Because the client device lacks a connection with the back-end server (e.g., due to lack of a connection to an intranet or the Internet), the user device may transmit, and the client device may receive, the request using near field communication (NFC), Bluetooth^{®}, or another type of short-range wireless communication technology. As used herein, “short-range” may refer to a signal with an effective distance of 150 meters or less.

In some implementations, the user device may be a smartphone. As a result, the user may use a wallet application (or another type of mobile app) to perform operations described in connection with FIG. 1A, which reduces implementation complexity. Additionally, the client device may be a smartphone. As a result, the client device may similarly use a wallet application (or another type of mobile app) to perform operations described in connection with FIGS. 1A and 1B, which reduces implementation complexity.

The request may include (e.g., in a header and/or as an argument) an indication of the user device (e.g., a device name, an IP address, a MAC address, and/or another alphanumeric identifier associated with the user device) and/or an indication of the back-end server (e.g., a device name, an IP address, a MAC address, and/or another alphanumeric identifier associated with the back-end server) that pre-authorized the event. The request may additionally, or alternatively, include an indication of the account (associated with the user of the user device) that was used to pre-authorize the event. For example, the indication of the account may include an account number, an account name, and/or an account type, among other examples.

In some implementations, a user of the client device may provide input (e.g., via an input component of the user device) that triggers the client device to accept the request from the user device. In one example, the user may interact with a UI (e.g., output by an output component of the client device) to provide the input. The UI may be as described in connection with FIG. 2B. In another example, the user may provide text input (e.g., via a command prompt or a shell, among other examples) that triggers the client device to accept the request.

As shown in FIG. 1A and by reference number 125, the client device may transmit, and the user device may receive, a prompt for a message confirming pre-authorization of the event. In some implementations, the client device may transmit, and the user device may receive, the prompt based on the client device lacking a connection with the back-end server. For example, the client device may determine (e.g., using a ping or another type of network test) that the client device lacks a connection to the back-end server (and/or a connection to the Internet altogether) and may transmit the prompt in response to determining that the client device lacks a connection to the back-end server. Because the client device lacks a connection with the back-end server, the client device may transmit, and the user device may receive, the prompt using NFC, Bluetooth, or another type of short-range wireless communication technology. Additionally, or alternatively, the client device may transmit, and the user device may receive, the prompt based on the request to process the event indicating that the event has been pre-authorized. For example, the client device may decode an indication of pre-authorization from the request and may transmit the prompt in response to decoding the indication of pre-authorization.

As shown by reference number 130, the user device may generate the message using the key provided by the back-end server. For example, the user device may sign a token, a certification, or another type of message using the key. Alternatively, the message may be (or at least include) the key. The message may indicate the account that was used to pre-authorize the event.

As shown by reference number 135, the user device may transmit, and the client device may receive, the message in response to the prompt. Because the client device lacks a connection with the back-end server, the user device may transmit, and the client device may receive, the message using NFC, Bluetooth, or another type of short-range wireless communication technology.

As shown by reference number 140, the client device may process the event based on the message. For example, the client device may approve a transaction, a deposit, a withdrawal, or another type of event. The client device may validate the message (e.g., verify that the message was signed or otherwise generated using a valid key from the back-end server) and may process the event in response to validating the message. In one example, the client device may apply a hash (or another type of algorithm) to a signature (or another portion of the message) in order to validate the message. Additionally, or alternatively, a signature (or another portion of the message) may be signed using a key (separate from the key provided to the user device) that matches a key provided to the client device by the back-end server (e.g., as a prerequisite to the client device processing offline transactions). The client device may additionally store the message from the user device. In some implementations, the client device may store the message securely (e.g., by encrypting the message using a storage key unique to the client device). Therefore, the message may remain secure if the client device is compromised in a data breach. Because the back-end server pre-authorized the event, the client device may not be subject to a time requirement for providing the message to the back-end server. Therefore, the client device may conserve memory and processing resources by storing the message without an associated timer.

As shown by reference number 145, the client device may transmit, and the user device may receive, a confirmation that the event was processed based on the message. The client device may transmit, and the user device may receive, the confirmation in response to the message. In some implementations, the user device may have a connection to the back-end server even when the client device does not. Accordingly, the user device may transmit, and the back-end server may receive, an indication that the client device confirmed the event (e.g., based on the confirmation from the client device), as shown by reference number 150. Alternatively, the user device may also lack a connection to the back-end server. Accordingly, the user device may transmit, and the back-end server may receive, the indication that the client device confirmed the event, at a later time when the user device has a connection with the back-end server. In implementations where the pre-authorization was for a maximum amount, the indication from the user device may indicate an amount associated with the event, such that the back-end server may update the hold on the account accordingly.

As shown in FIG. 1B and by reference number 155, the client device may establish a connection with the back-end server (e.g., at a later time). For example, the back-end server may re-establish connection to an intranet or the Internet in order to connect to the back-end server. In response to establishing a connection with the back-end server, the client device may transmit, and the back-end server may receive, the message (from the user device), as shown by reference number 160. The message may be included in an HTTP message, in an FTP message, and/or as an argument in an API call. In one example, the client device may forward the message directly from a cache (or another memory controlled by the client device) to the back-end server (and thus directly from the user device to the back-end server after briefly being stored at the client device). In another example, the client device may decode information from the message (after receiving the message from the user device and either before storage of the message or after re-establishing a connection with the back-end server) and re-encode the information into a new envelope for transmitting to the back-end server.

As shown by reference number 165, the back-end server may verify the event against the account (of the user of the user device). For example, the back-end server may map the message to the key (stored at a memory of the back-end server) and may adjust a data structure (representing the account) based on approval of the event. The back-end server may adjust the data structure to subtract the amount, associated with the event, from the account. The amount may be indicated in the message and/or the indication from the user device, as described above in connection with reference number 150. The back-end server may additionally add the amount, associated with the event, to an account associated with the client device (e.g., by adjusting a data structure representing the account associated with the client device). Additionally, the back-end server may disable the hold on the account. For example, the back-end server may remove a flag that was stored in association with the account (and with the key), as described above in connection with reference number 110. The back-end server may disable the hold on the account in response to subtracting the amount from the account (and optionally in response to adding the amount to the account associated with the client device).

In some implementations, the back-end server may discard (e.g., remove from memory) the key in response to verifying the event. Therefore, the back-end server may conserve memory and may improve security by preventing a double spend of the key.

In some implementations, the back-end server may validate a set of credentials from the client device before verifying the event. The set of credentials may include a username and password, a passcode, a PIN, a token, a (signed) certificate, and/or biometric information, among other examples. In one example, the client device may include the set of credentials with the message, such that the back-end server validates the set of credentials and verifies the event in response to validating the set of credentials. In another example, the client device may transmit the set of credentials before the message, such that the back-end server validates the set of credentials and accepts the message from the client device in response to validating the set of credentials. In another example, the back-end server may prompt the client device in response to the message, and the client device may transmit the set of credentials in response to the prompt.

As shown by reference number 170, the back-end server may transmit, and the client device may receive, a confirmation that the event has been verified. The confirmation may be included in an HTTP response, an FTP response, or a return from an API function. The back-end server may transmit, and the client device may receive, the confirmation in response to the message from the client device.

Accordingly, in some implementations, the client device may discard (e.g., remove from memory) the message in response to the confirmation. Therefore, the client device may further conserve memory.

By using techniques as described in connection with FIGS. 1A-1B, the back-end server pre-authorizes the event in response to the request from the user device. Therefore, the back-end server is unlikely to reject the event because the event was pre-authorized, which conserves power and processing resources that otherwise would have been spent by the client device in trying to rectify the event if rejected.

As indicated above, FIGS. 1A-1B are provided as an example. Other examples may differ from what is described with regard to FIGS. 1A-1B.

FIGS. 2A and 2B are diagrams of example UI flows 200 and 250 associated with offline event processing using pre-authorization. The example UI flow 200 of FIG. 2A may be output by a user device, and the example UI flow 250 of FIG. 2B may be output by a client device. These devices are described in more detail in connection with FIGS. 3 and 4.

As shown in FIG. 2A, the example UI flow 200 may include a first UI 210. The first UI 210 may include a graphical representation 211 of an account to be used to pre-authorize an event. The first UI 210 may further include a textual representation 213 of an amount (or a maximum amount) associated with the event. The account and the amount may be indicated by input from a user of the user device. The first UI 210 may further include a button 215 (or another type of confirmation element) that triggers the user device to request a key from a back-end device (where the key may be used to confirm pre-authorization of the event). In response to using the key to request the client device to process the event, the user device may output a second UI 220 (in the example UI flow 200). The second UI 220 may include a graphical representation 221 and/or a textual representation 223 that the client device processed the event.

As shown in FIG. 2B, the example UI flow 250 may include a first UI 260. The first UI 260 may include a graphical representation 261 and/or a textual representation 263 that the user device should be close enough to engage in short-range communications with the client device. The client device may engage in short-range communications with the user device in response to input from a user of the client device. In response to processing an event offline (e.g., based on a message, from the user device, that was generated using the key), the client device may output a second UI 270 (in the example UI flow 250). The second UI 270 may include a graphical representation 271 and/or a textual representation 273 that the client device processed the event. Additionally, or alternatively, the second UI 270 may include a graphical representation 275 and/or a textual representation 277 of instructions about verifying the event when a connection to the back-end server is re-established. Additionally, or alternatively, the second UI 270 may include a graphical representation 279 and/or a textual representation 281 of no time limit for verifying the event.

As indicated above, FIGS. 2A-2B are provided as examples. Other examples may differ from what is described with regard to FIGS. 2A-2B.

FIG. 3 is a diagram of an example environment 300 in which systems and/or methods described herein may be implemented. As shown in FIG. 3, environment 300 may include a back-end server 301, which may include one or more elements of and/or may execute within a cloud computing system 302. The cloud computing system 302 may include one or more elements 303-312, as described in more detail below. As further shown in FIG. 3, environment 300 may include a network 320, a user device 330, a client device 340, and/or a storage device 350. Devices and/or elements of environment 300 may interconnect via wired connections and/or wireless connections.

The cloud computing system 302 may include computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

The computing hardware 303 may include hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, and/or one or more networking components 309. Examples of a processor, a memory, and a networking component (e.g., a communication component) are described elsewhere herein.

The resource management component 304 may include a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 310. Additionally, or alternatively, the resource management component 304 may include a container manager, such as when the virtual computing systems 306 are containers 311. In some implementations, the resource management component 304 executes within and/or in coordination with a host operating system 305.

A virtual computing system 306 may include a virtual environment that enables cloud-based execution of operations and/or processes described herein using computing hardware 303. As shown, a virtual computing system 306 may include a virtual machine 310, a container 311, or a hybrid environment 312 that includes a virtual machine and a container, among other examples. A virtual computing system 306 may execute one or more applications using a file system that includes binary files, software libraries, and/or other resources required to execute applications on a guest operating system (e.g., within the virtual computing system 306) or the host operating system 305.

Although the back-end server 301 may include one or more elements 303-312 of the cloud computing system 302, may execute within the cloud computing system 302, and/or may be hosted within the cloud computing system 302, in some implementations, the back-end server 301 may not be cloud-based (e.g., may be implemented outside of a cloud computing system) or may be partially cloud-based. For example, the back-end server 301 may include one or more devices that are not part of the cloud computing system 302, such as device 400 of FIG. 4, which may include a standalone server or another type of computing device. The back-end server 301 may perform one or more operations and/or processes described in more detail elsewhere herein.

The network 320 may include one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The user device 330 may include one or more devices capable of receiving, generating, storing, processing, and/or providing information associated with events, as described elsewhere herein. The user device 330 may include a communication device and/or a computing device. For example, the user device 330 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The user device 330 may communicate with one or more other devices of environment 300, as described elsewhere herein.

The client device 340 may include one or more devices capable of receiving, generating, storing, processing, and/or providing information associated with events, as described elsewhere herein. The client device 340 may include a communication device and/or a computing device. For example, the client device 340 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device. The client device 340 may communicate with one or more other devices of environment 300, as described elsewhere herein.

The storage device 350 may include one or more devices capable of receiving, generating, storing, processing, and/or providing information associated with accounts and/or keys, as described elsewhere herein. The storage device 350 may include a communication device and/or a computing device. For example, storage device 350 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The storage device 350 may communicate with one or more other devices of environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400 associated with offline event processing using pre-authorization. The device 400 corresponds to one or more of a user device 330, a client device 340, and/or a storage device 350. In some implementations, a user device 330, a client device 340, and/or a storage device 350 may include one or more devices 400 and/or one or more components of the device 400. In the example shown in FIG. 4, the device 400 includes a bus 410, a processor 420, a memory 430, an input component 440, an output component 450, and/or a communication component 460.

The bus 410 includes one or more components that enable wired and/or wireless communication among the components of the device 400. The bus 410 couples together two or more components of FIG. 4, such as via operative coupling, communicative coupling, electronic coupling, and/or electric coupling. For example, the bus 410 may include an electrical connection (e.g., a wire, a trace, and/or a lead) and/or a wireless bus. The processor 420 includes a central processing unit, a graphics processing unit, a microprocessor, a controller, a microcontroller, a digital signal processor, a field-programmable gate array, an application-specific integrated circuit, and/or another type of processing component. The processor 420 may be implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory, such as random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). In some implementations, the memory 430 is a non-transitory computer-readable medium. The memory 430 stores information, one or more instructions, and/or software (e.g., one or more software applications) related to the operation of the device 400. In some implementations, the memory 430 includes one or more memories that are coupled (e.g., communicatively coupled) to one or more processors (e.g., processor 420), such as via the bus 410. Communicative coupling between a processor 420 and a memory 430 enables the processor 420 to read and/or process information stored in the memory 430 and/or to store information in the memory 430.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

In some implementations, the device 400 performs one or more operations or processes described herein. For example, a non-transitory computer-readable medium (e.g., memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry is used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

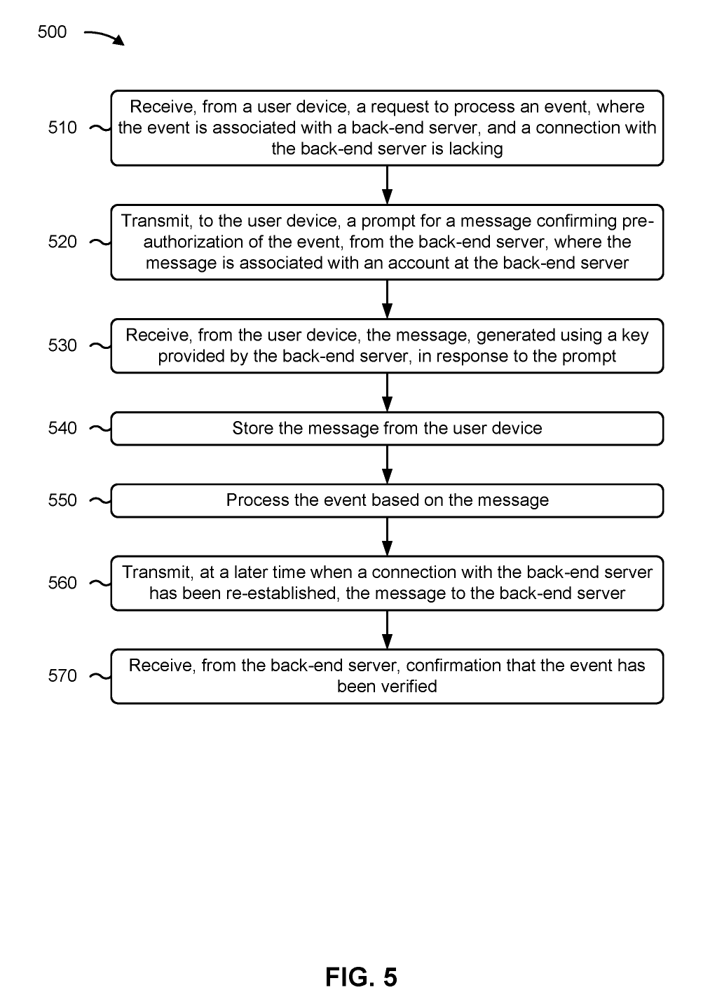

FIG. 5 is a flowchart of an example process 500 associated with offline event processing using pre-authorization. In some implementations, one or more process blocks of FIG. 5 may be performed by a client device 340. In some implementations, one or more process blocks of FIG. 5 may be performed by another device or a group of devices separate from or including the client device 340, such as a back-end server 301, a user device 330, and/or a storage device 350. Additionally, or alternatively, one or more process blocks of FIG. 5 may be performed by one or more components of the device 400, such as processor 420, memory 430, input component 440, output component 450, and/or communication component 460.

As shown in FIG. 5, process 500 may include receiving, from a user device, a request to process an event, where the event is associated with a back-end server, and a connection with the back-end server is lacking (block 510). For example, the client device 340 (e.g., using processor 420, memory 430, and/or communication component 460) may receive, from a user device, a request to process the event that is associated with a back-end server, as described above in connection with reference number 120 of FIG. 1A. The client device 340 may lack a connection with the back-end server, and thus the client device 340 may receive the request using NFC, Bluetooth, or another type of short-range wireless communication technology.

As further shown in FIG. 5, process 500 may include transmitting, to the user device, a prompt for a message confirming pre-authorization of the event, from the back-end server, where the message is associated with an account at the back-end server (block 520). For example, the client device 340 (e.g., using processor 420, memory 430, and/or communication component 460) may transmit, to the user device, a prompt for a message confirming pre-authorization of the event, from the back-end server, where the message is associated with an account at the back-end server, as described above in connection with reference number 125 of FIG. 1A. As an example, the client device 340 may determine (e.g., using a ping or another type of network test) that the client device 340 lacks a connection to the back-end server (and/or a connection to the Internet altogether) and may transmit the prompt in response to determining that the client device 340 lacks a connection to the back-end server. Additionally, or alternatively, the client device 340 may decode an indication of pre-authorization from the request and may transmit the prompt in response to decoding the indication of pre-authorization. Because the client device 340 lacks a connection with the back-end server, the client device 340 may transmit the prompt using NFC, Bluetooth, or another type of short-range wireless communication technology.

As further shown in FIG. 5, process 500 may include receiving, from the user device, the message, generated using a key provided by the back-end server, in response to the prompt (block 530). For example, the client device 340 (e.g., using processor 420, memory 430, and/or communication component 460) may receive, from the user device, the message, generated using a key provided by the back-end server, in response to the prompt, as described above in connection with reference number 135 of FIG. 1A. Because the client device 340 lacks a connection with the back-end server, the client device 340 may receive the message using NFC, Bluetooth, or another type of short-range wireless communication technology.

As further shown in FIG. 5, process 500 may include storing the message from the user device (block 540). For example, the client device 340 (e.g., using processor 420 and/or memory 430) may store the message from the user device, as described above in connection with FIG. 1A. Because the back-end server pre-authorized the event, the client device 340 may conserve memory and processing resources by storing the message without an associated timer.

As further shown in FIG. 5, process 500 may include processing the event based on the message (block 550). For example, the client device 340 (e.g., using processor 420 and/or memory 430) may process the event based on the message, as described above in connection with reference number 140 of FIG. 1A. As an example, the client device 340 may approve a transaction, a deposit, a withdrawal, or another type of event.

As further shown in FIG. 5, process 500 may include transmitting, at a later time when a connection with the back-end server has been re-established, the message to the back-end server (block 560). For example, the client device 340 (e.g., using processor 420, memory 430, and/or communication component 460) may transmit, at a later time when a connection with the back-end server has been re-established, the message to the back-end server, as described above in connection with reference number 160 of FIG. 1B. In one example, the client device 340 may forward the message directly from a cache (or another memory controlled by the client device 340) to the back-end server. In another example, the client device 340 may decode information from the message and re-encode the information into a new envelope for transmitting to the back-end server.

As further shown in FIG. 5, process 500 may include receiving, from the back-end server, confirmation that the event has been verified (block 570). For example, the client device 340 (e.g., using processor 420, memory 430, and/or communication component 460) may receive, from the back-end server, confirmation that the event has been verified, as described above in connection with reference number 170 of FIG. 1B. The client device 340 may receive the confirmation in response to the message transmitted to the back-end server.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel. The process 500 is an example of one process that may be performed by one or more devices described herein. These one or more devices may perform one or more other processes based on operations described herein, such as the operations described in connection with FIGS. 1A-1B and/or FIG. 2B. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

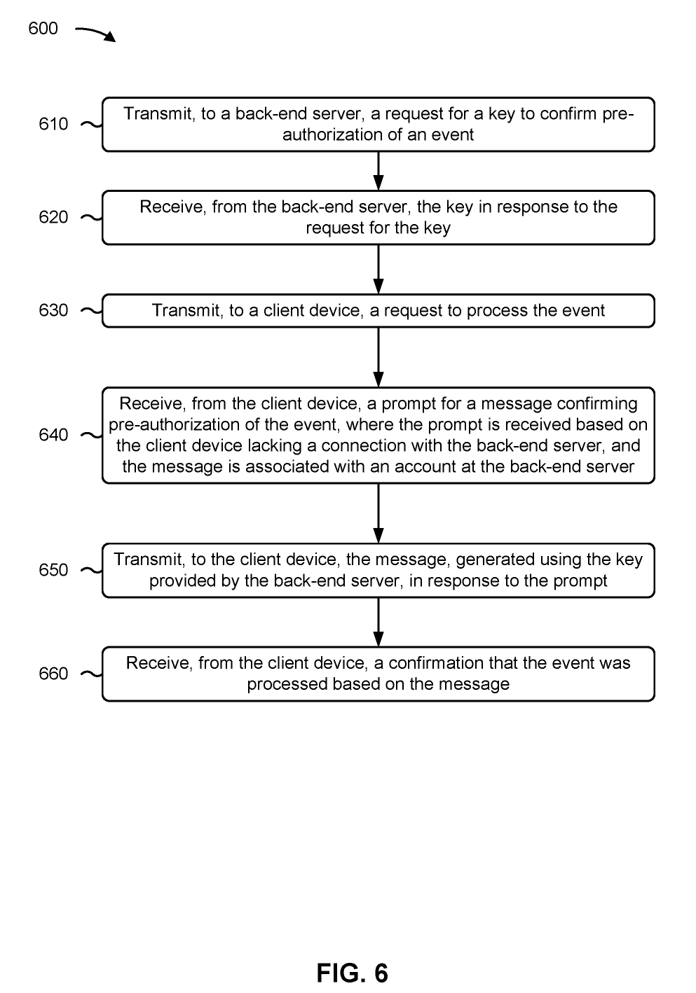

FIG. 6 is a flowchart of an example process 600 associated with offline event processing using pre-authorization. In some implementations, one or more process blocks of FIG. 6 may be performed by a user device 330. In some implementations, one or more process blocks of FIG. 6 may be performed by another device or a group of devices separate from or including the user device 330, such as a back-end server 301, a client device 340, and/or a storage device 350. Additionally, or alternatively, one or more process blocks of FIG. 6 may be performed by one or more components of the device 400, such as processor 420, memory 430, input component 440, output component 450, and/or communication component 460.

As shown in FIG. 6, process 600 may include transmitting, to a back-end server, a request for a key to confirm pre-authorization of an event (block 610). For example, the user device 330 (e.g., using processor 420, memory 430, and/or communication component 460) may transmit, to a back-end server, a request for a key to confirm pre-authorization of an event, as described above in connection with reference number 105 of FIG. 1A. As an example, a user of the user device 330 may provide input (e.g., via input component 440) that triggers the user device 330 to transmit the request. The request may include an indication of the user device 330, an indication of a client device that will process the event, and/or an indication of an account (associated with the user of the user device) to use to pre-authorize the event.

As further shown in FIG. 6, process 600 may include receiving, from the back-end server, the key in response to the request for the key (block 620). For example, the user device 330 (e.g., using processor 420, memory 430, and/or communication component 460) may receive, from the back-end server, the key in response to the request for the key, as described above in connection with reference number 115 of FIG. 1A. As an example, the key may be included in an HTTP response, an FTP response, and/or a return from an API function.

As further shown in FIG. 6, process 600 may include transmitting, to a client device, a request to process the event (block 630). For example, the user device 330 (e.g., using processor 420, memory 430, and/or communication component 460) may transmit, to a client device, a request to process the event, as described above in connection with reference number 120 of FIG. 1A. Because the client device may lack a connection with the back-end server (e.g., due to lack of a connection to an intranet or the Internet), the user device 330 may transmit the request using NFC, Bluetooth, or another type of short-range wireless communication technology.

As further shown in FIG. 6, process 600 may include receiving, from the client device, a prompt for a message confirming pre-authorization of the event, where the prompt is received based on the client device lacking a connection with the back-end server, and the message is associated with an account at the back-end server (block 640). For example, the user device 330 (e.g., using processor 420, memory 430, and/or communication component 460) may receive, from the client device, a prompt for a message confirming pre-authorization of the event, where the prompt is received based on the client device lacking a connection with the back-end server, and where the message is associated with an account at the back-end server, as described above in connection with reference number 125 of FIG. 1A. Because the client device 340 lacks a connection with the back-end server, the user device 330 may receive the prompt using NFC, Bluetooth, or another type of short-range wireless communication technology.

As further shown in FIG. 6, process 600 may include transmitting, to the client device, the message, generated using the key provided by the back-end server, in response to the prompt (block 650). For example, the user device 330 (e.g., using processor 420, memory 430, and/or communication component 460) may transmit, to the client device, the message, generated using the key provided by the back-end server, in response to the prompt, as described above in connection with reference number 135 of FIG. 1A. As an example, the user device 330 may sign a token, sign a certification, or otherwise generate the message using the key (from the back-end server) in order to confirm pre-authorization of the event.

As further shown in FIG. 6, process 600 may include receiving, from the client device, a confirmation that the event was processed based on the message (block 660). For example, the user device 330 (e.g., using processor 420, memory 430, and/or communication component 460) may receive, from the client device, a confirmation that the event was processed based on the message, as described above in connection with reference number 145 of FIG. 1A. The user device 330 may receive the confirmation in response to the message transmitted to the client device.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel. The process 600 is an example of one process that may be performed by one or more devices described herein. These one or more devices may perform one or more other processes based on operations described herein, such as the operations described in connection with FIGS. 1A-1B and/or FIG. 2A. Moreover, while the process 600 has been described in relation to the devices and components of the preceding figures, the process 600 can be performed using alternative, additional, or fewer devices and/or components. Thus, the process 600 is not limited to being performed with the example devices, components, hardware, and software explicitly enumerated in the preceding figures.

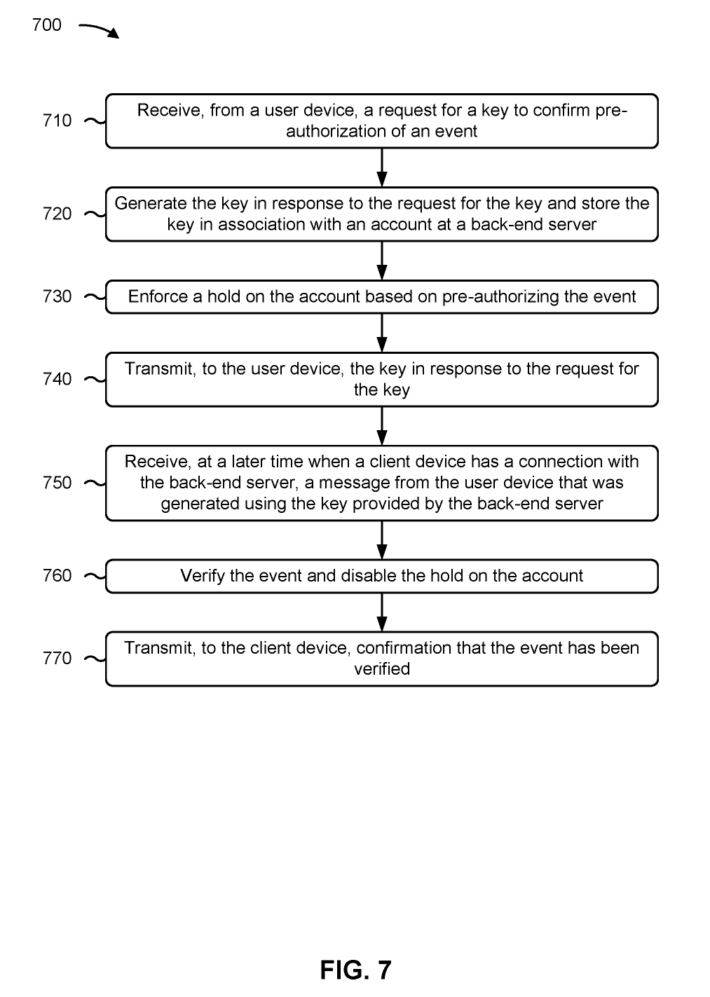

FIG. 7 is a flowchart of an example process 700 associated with offline event processing using pre-authorization. In some implementations, one or more process blocks of FIG. 7 may be performed by a back-end server 301. In some implementations, one or more process blocks of FIG. 7 may be performed by another device or a group of devices separate from or including the back-end server 301, such as a user device 330, a client device 340, and/or a storage device 350. Additionally, or alternatively, one or more process blocks of FIG. 7 may be performed by one or more components of the device 400, such as processor 420, memory 430, input component 440, output component 450, and/or communication component 460.

As shown in FIG. 7, process 700 may include receiving, from a user device, a request for a key to confirm pre-authorization of the event (block 710). For example, the back-end server 301 (e.g., using processor 420, memory 430, and/or communication component 460) may receive, from a user device, a request for a key to confirm pre-authorization of the event, as described above in connection with reference number 105 of FIG. 1A. The request may include an indication of the user device, an indication of a client device that will process the event, and/or an indication of an account (associated with the user of the user device) to use to pre-authorize the event.

As further shown in FIG. 7, process 700 may include generating the key in response to the request for the key and store the key in association with an account at a back-end server (block 720). For example, the back-end server 301 (e.g., using processor 420 and/or memory 430) may generate the key in response to the request for the key and store the key in association with an account at a back-end server, as described above in connection with reference number 110 of FIG. 1A. As an example, the back-end server 301 may validate a set of credentials from the user device and may generate the key in response to validating the set of credentials.

As further shown in FIG. 7, process 700 may include enforcing a hold on the account based on pre-authorizing the event (block 730). For example, the back-end server 301 (e.g., using processor 420 and/or memory 430) may enforce a hold on the account based on pre-authorizing the event, as described above in connection with FIG. 1A. As an example, the hold on the account may include a modification to a data structure (which represents the account) to prevent an amount (or a maximum amount) indicated in the request from being subtracted from the account. Additionally, or alternatively, the back-end server 301 may store a flag in association with the key and with (the data structure representing) the account so that the back-end server 301 may later map the key to the account (and/or the account to the key).

As further shown in FIG. 7, process 700 may include transmitting, to the user device, the key in response to the request for the key (block 740). For example, the back-end server 301 (e.g., using processor 420, memory 430, and/or communication component 460) may transmit, to the user device, the key in response to the request for the key, as described above in connection with reference number 115 of FIG. 1A. As an example, the key may be included in an HTTP response, an FTP response, and/or a return from an API function.

As further shown in FIG. 7, process 700 may include receiving, at a later time when a client device has a connection with the back-end server, a message from the user device that was generated using the key provided by the back-end server (block 750). For example, the back-end server 301 (e.g., using processor 420, memory 430, and/or communication component 460) may receive, at a later time when a client device has a connection with the back-end server, a message from the user device that was generated using the key provided by the back-end server, as described above in connection with reference number 160 of FIG. 1B. As an example, the client device may forward the message that was received from the user device and was used to process the event offline.

As further shown in FIG. 7, process 700 may include verifying the event and disable the hold on the account (block 760). For example, the back-end server 301 (e.g., using processor 420 and/or memory 430) may verify the event and disable the hold on the account, as described above in connection with reference number 165 of FIG. 1B. As an example, the back-end server 301 may map the message to the key and may adjust the data structure (representing the account) based on approval of the event (e.g., by subtracting an amount, associated with the event, from the account). Additionally, or alternatively, the back-end server may remove the flag that was stored in association with the account (and with the key), as described above in connection with block 730.

As further shown in FIG. 7, process 700 may include transmitting, to the client device, confirmation that the event has been verified (block 770). For example, the back-end server 301 (e.g., using processor 420, memory 430, and/or communication component 460) may transmit, to the client device, confirmation that the event has been verified, as described above in connection with reference number 170 of FIG. 1B. The back-end server 301 may transmit the confirmation in response to the message received from the client device.

Although FIG. 7 shows example blocks of process 700, in some implementations, process 700 may include additional blocks, fewer blocks, different blocks, or differently arranged blocks than those depicted in FIG. 7. Additionally, or alternatively, two or more of the blocks of process 700 may be performed in parallel. The process 700 is an example of one process that may be performed by one or more devices described herein. These one or more devices may perform one or more other processes based on operations described herein, such as the operations described in connection with FIGS. 1A-1B. Moreover, while the process 700 has been described in relation to the devices and components of the preceding figures, the process 700 can be performed using alternative, additional, or fewer devices and/or components. Thus, the process 700 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for processing an event offline, the system comprising:
one or more memories; and
one or more processors, communicatively coupled to the one or more memories, configured to:
receive, from a user device, a request to process the event, wherein the event is associated with a back-end server, and the system lacks a connection with the back-end server;
transmit, to the user device, a prompt for a message confirming pre-authorization of the event, from the back-end server, wherein the message is associated with an account at the back-end server;
receive, from the user device, the message, generated using a key provided by the back-end server, in response to the prompt;
store the message from the user device;
process the event based on the message;
transmit, at a later time when the system has a connection with the back-end server, the message to the back-end server; and
receive, from the back-end server, confirmation that the event has been verified.

2. The system of claim 1, wherein the user device comprises a first smartphone.

3. The system of claim 2, wherein the system comprises a second smartphone.

4. The system of claim 1, wherein the message comprises a token that is signed using the key and that indicates the account.

5. The system of claim 1, wherein the one or more processors, to transmit the prompt to the user device, are configured to:
transmit the prompt using near field communication or Bluetooth.

6. The system of claim 1, wherein the one or more processors, to receive the message from the user device, are configured to:
receive the message using near field communication or Bluetooth.

7. A method of processing an event offline, comprising:
transmitting, from a user device and to a back-end server, a request for a key to confirm pre-authorization of the event;
receiving, at the user device and from the back-end server, the key in response to the request for the key;
transmitting, from the user device and to a client device, a request to process the event;
receiving, at the user device and from the client device, a prompt for a message confirming pre-authorization of the event, wherein the prompt is received based on the client device lacking a connection with the back-end server, and wherein the message is associated with an account at the back-end server;
transmitting, from the user device and to the client device, the message, generated using the key provided by the back-end server, in response to the prompt; and
receiving, at the user device and from the client device, a confirmation that the event was processed based on the message.

8. The method of claim 7, wherein the request for the key indicates the client device.

9. The method of claim 7, wherein the request for the key indicates an amount associated with the event.

10. The method of claim 7, wherein the request for the key indicates a maximum amount.

11. The method of claim 7, further comprising:
transmitting, from the user device and to the back-end server, an indication that the client device confirmed the event based on the confirmation from the client device.

12. The method of claim 11, wherein the indication includes an amount associated with the event.

13. The method of claim 7, wherein the user device comprises a first smartphone.

14. The method of claim 13, wherein the client device comprises a second smartphone.

15. A non-transitory computer-readable medium storing a set of instructions for processing an event offline, the set of instructions comprising:
one or more instructions that, when executed by one or more processors of a device, cause the device to:
receive, from a user device, a request for a key to confirm pre-authorization of the event;
generate the key in response to the request for the key and store the key in association with an account at a back-end server;
enforce a hold on the account based on pre-authorizing the event;
transmit, to the user device, the key in response to the request for the key;
receive, at a later time when a client device has a connection with the back-end server, a message from the user device that was generated using the key provided by the back-end server;
verify the event and disable the hold on the account; and
transmit, to the client device, confirmation that the event has been verified.

16. The non-transitory computer-readable medium of claim 15, wherein the key comprises a private key used by the user device to sign the message.

17. The non-transitory computer-readable medium of claim 15, wherein the message comprises the key.

18. The non-transitory computer-readable medium of claim 15, wherein the one or more instructions, that cause the device to enforce the hold on the account, cause the device to:
store a flag in association with the key and the account.

19. The non-transitory computer-readable medium of claim 15, wherein the one or more instructions, that cause the device to disable the hold on the account, cause the device to:
remove a flag that was stored in association with the key and the account.

20. The non-transitory computer-readable medium of claim 15, wherein the one or more instructions, that cause the device to verify the event, cause the device to:
map the message to the key; and
adjust a data structure, representing the account associated with the key, based on approval of the event.
